(19) United States
(12) Patent Application Publication
(10) Pub. No.: US 2010/0169019 A1
(43) Pub. Date: Jul. 1, 2010

(54) FORMATION EVALUATION USING LOCAL DYNAMIC UNDER-BALANCE IN PERFORATING

(75) Inventors: Lang Zhan, Pearland, TX (US); Jeremy P. Harvey, Houston, TX (US); Brenden M. Grove, Missouri City, TX (US); Harvey A. R. Williams, Houston, TX (US); Lawrence A. Behrmann, Houston, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/419,264

(22) Filed: Apr. 6, 2009

Related U.S. Application Data
(60) Provisional application No. 61/140,938, filed on Dec. 27, 2008.

(51) Int. Cl. G01N 15/08

(52) U.S. Cl. 702/12

(57) ABSTRACT

Methods for estimating an unknown value for a dynamic under-balance condition are herein disclosed. The unknown value may be a well property value, or may be a transient pressure characteristic. Embodiments of the method include selecting at least one transient pressure characteristic and selecting at least one well property value. A correlation between the at least one transient pressure characteristic and at least one well property value is obtained. The unknown value is estimated by applying at least one known transient pressure characteristic or at least one known well property value to the obtained correlation.

### CROSS REFERENCE TO RELATED APPLICATIONS

This application relates to and claims priority from U.S. Provisional Patent Application Ser. No. 61/140,938, filed Dec. 27, 2008, which is incorporated herein by reference.

### FIELD OF THE DISCLOSURE

The present application generally relates to perforating, and more specifically perforating involving dynamic under-balanced conditions.

### BACKGROUND

In the following description, numerous details are set forth to provide an understanding of the embodiments described herein. However, it will be understood by those skilled in the art that the presently disclosed embodiments may be practiced without many of these details and that numerous variations or modifications from the described embodiments are possible.

The terms “above” and “below”; “up” and “down”; “upper” and “lower”; “upwardly” and “downwardly”; and other like terms indicating relative position above or below a given point or element are used in this description to more clearly describe some embodiments. However, when applied to equipment and methods for use in wells that are deviated or horizontal, such terms may refer to a left to right, right to left, or diagonal relationship as appropriate.

Formation permeability dictates fluid flow in a hydrocarbon reservoir and determines the productivity of a well. Therefore, permeability is an important formation property for reservoir management and performance prediction. Pressure transient testing has been widely used to estimate the permeability of a formation. Pressure transient testing is usually conducted with drill stem test (DST) tools and/or a wireline formation tester (WFT).

A DST tool string can include various bottom-hole flow control valves, production packers, and pressure gauges. A DST requires producing formation fluids to the surface or into the tubing string that conveyed the DST tools. The DST operation includes one or more short flowing and shut-in cycles for cleanup before a main flowing and shut-in test. The short flowing and shut-in periods in a DST usually last about ten minutes to several hours. The main flowing and shut-in periods often last about ten hours to several days or even longer. The flowing and buildup periods in a DST can last anywhere from 15 minutes to 2 weeks or more. The produced formation fluid volume can be anywhere from 1 barrel to 100,000 barrels or more. A DST provides robust estimates of the formation parameters from its detailed investigation. However, because DST involves a drilling rig, long testing times, and a large amount of produced hydrocarbon or other fluids from the formation, it requires a significant investment and considerable time for preparation and execution. There are also many environmental and safety risks associated with a DST.

A Wireline Formation Tester (WFT), such as the Modular Formation Dynamic Tester (MDT), available from Schlumberger Technology Corporation, is one of the primary tools to be used in formation evaluation at the early stages after a well is drilled. The WFT uses either a dual-packer or a probe against a wellbore sandface to isolate a small segment of the wellbore. A pump installed in the WFT withdraws formation fluids into fluid samplers of the tool system or into the wellbore either through a packed-off segment between the two WFT packers or through the WFT probe set against the formation sandface. A pressure transient generated by the fluid withdrawal and subsequent shut-in can be used to infer formation mobility. The formation tests of a WFT include pressure drawdown periods that occur during pumping out operations and subsequent pressure buildup periods that occur when the pumping out terminates. The typical production time and pressure buildup time from a WFT for a formation property estimation is about two minutes to two hours and the total produced formation fluid volume is about 10⁻² to 10⁰ barrel of formation fluids. A WFT minimizes the undesirable features and difficulties associated with a DST because there is minimal or no hydrocarbon production to the surface and no requirement for extensive surface equipment for the test. However, a WFT investigates a much smaller formation volume than a DST and is usually operated in an open-hole wellbore. Therefore, a WFT is not suitable for use in a completed cased wellbore.

If a well is cased, perforating is necessary to allow formation fluids to flow into the wellbore. U.S. Pat. Nos. 6,598,682, 6,966,377, 7,121,340, and 7,182,138, which are fully incorporated herein by reference, generally relate to perforating techniques and apparatus that create a better fluid communication between the formation and the wellbore through a local dynamic under-balance. Various conveyance methods, such as tubing string used for DST, wireline, or coiled tubing, can be used to position the perforating system for generating the under-balance condition. The local dynamic under-balance generated by these techniques occurs over a very short period of time, usually in about tens of milliseconds (10⁻² to 10⁻¹ seconds). The total volume of the produced fluids from the formation is unknown but cannot be larger than the volume of the inner gun volume if the wellbore fluid pressure is the same as the reservoir pressure before perforating. The reason is that a portion of the inner gun volume may be filled by the wellbore fluid. Many field applications of the technique have resulted in substantial perforating damage removal and well productivity increases.

### BRIEF DISCLOSURE

The present disclosure relates to methods to predict characteristics of the transient pressure occurring during a local dynamic under-balance condition before a local dynamic under-balance operation is performed. The present disclosure also relates to methods that use the transient pressure measurements recorded during the local dynamic under-balance condition for formation evaluation in addition to improved well casing perforation and well productivity enhancement.

This present disclosure presents methods to predict transient pressure characteristics for a future local dynamic under-balance operation. Specifically, one embodiment includes selecting a transient pressure characteristic value to estimate and determining a set of at least two known well property values for the future local dynamic under-balance operation. Then, each of the known well property values in the set is applied to an optimal transform correlating the property values to the selected transient pressure characteristic value, and a transformed known well property value is obtained for each of the known property values in the set. Then, the transformed well property values are summed to obtain a transformed well property summation. Next, the transformed well property summation is applied to a transformation correlating the well property summation with the selected transient pressure characteristic value. Next, a transformed characteristic value is obtained. Finally, the transient pressure characteristic value is estimated by applying the transformed characteristic value to an optimal transformation for the selected transient pressure characteristic.

The application also relates to methods to estimate well property values from a local dynamic under-balance condition created close to the targeted formation. Specifically, one embodiment includes estimating a transient pressure characteristic; correlating the transient pressure characteristic to at least one known well property value; obtaining an unknown well property correlation; and, estimating the unknown well property value from the unknown well property correlation.

### BRIEF DESCRIPTION OF THE DRAWINGS

FIG. 1 depicts a tool system for generating a local dynamic under-balance condition;

FIG. 2 is a graph depicting an exemplary transient pressure history;

FIG. 3 is a flow chart depicting an embodiment of a method for obtaining the relationship between a transient pressure characteristic and a set of well properties;

FIG. 4 is a graph depicting an exemplary transform for an initial wellbore pressure;

FIG. 5 is a graph depicting an exemplary transform for a number of special charges;

FIG. 6 is graph depicting an exemplary transform for a number of conventional charges;

FIG. 7 is a graph depicting an exemplary transform for a well casing inside diameter;

FIG. 8 is a graph depicting an exemplary transform for a perforation gun outside diameter;

FIG. 9 is a graph depicting an exemplary transform for an explosive mass per conventional charge;

FIG. 10 is a graph depicting an exemplary transform for a perforation gun length;

FIG. 11 is a graph depicting an exemplary transform for a perforated length on the gun;

FIG. 12 is a graph depicting an exemplary transform for the permeability of the formation;

FIG. 13 is a graph depicting an exemplary transform for a total free volume inside the perforation gun;

FIG. 14 is a graph depicting an exemplary transform for a total perforated hole area on the perforation gun;

FIG. 15 is a graph depicting an exemplary transform for a wellbore fluid density;

FIG. 16 is graph depicting an exemplary transform for a delta P;

FIG. 17 is a graph depicting an exemplary transform for a duration of the local dynamic under-balance (dt₄);

FIG. 18 is a graph depicting an exemplary correlation between a summation of the transformed well properties and a transformed transient pressure characteristic;

FIG. 19 is a flow chart depicting an embodiment of the steps for predicting a transient pressure characteristic;

FIG. 20 is a flow chart depicting the steps of an embodiment for estimating a well property from a transient pressure characteristic; and

FIG. 21 depicts a communication system for use with a tool system and a computer.

### DETAILED DESCRIPTION OF THE DRAWINGS

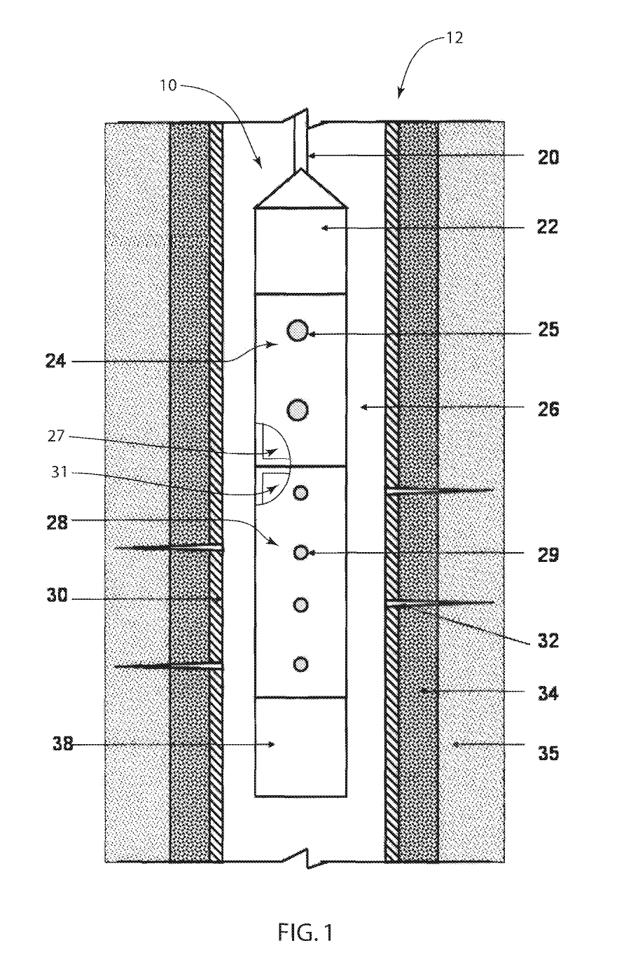

FIG. 1 depicts a tool system 10 to generate a local dynamic under-balance condition. In the embodiment depicted in FIG. 1, the tool system 10 is a perforation gun system. The perforation gun system 10 is lowered into the well bore 26 of a well 12 that extends from the surface (not depicted) into a formation 35 containing hydrocarbons. The well 12 includes a well casing 30 and a cement sheath 34 that separate the formation 35 from the wellbore 26.

The perforation gun system 10 includes a wireline cable 20 or other conveyance device such as, but not limited to, tubing string, or coiled tubing to connect the perforation gun system 10 to the surface (not depicted). In the embodiment disclosed, the perforation gun system 10 is used to generate a local dynamic under-balance (DUB) condition within the wellbore 26 of the well 12. The perforation gun system 10 includes an adaptor 22. The adaptor 22 includes various necessary devices (not depicted) to facilitate communication between the perforation gun system 10 and the perforation gun system operators on the surface. The adaptor 22 may also include a variety of devices, such as casing collar locator (CCL) (not depicted) used to position the perforation gun system 10 at a targeted location in the well 12.

The perforation gun system 10 further includes a sealed chamber 24 with a low pressure trapped in an inner space 27 of the chamber 24. Plural devices 25 are installed in association with the sealed chamber 24. The plural devices 25 are special charges that are used to open the sealed chamber 24 without penetrating or damaging the well casing 30. These devices 25, when activated, establish fluid flow communication between the inner space 27 of the chamber 24 and the wellbore 26 of the well 12. In an embodiment, the devices 25 are special charges designed to rupture fluid communication ports (not depicted) on the sealed chamber 24.

The perforation gun system 10 also includes a perforating gun 28, in which standard, or perforating, charges 29 are installed. The perforating charges 29, when activated, create a perforating jet that penetrates the well casing 30 and the cement sheath 34 with fissures 32 that extend into the formation 35. The fissures 32 establish fluid communication between the formation 35 and wellbore 26.

The charges 29 of the perforating gun 28 may also serve the function of creating fluid communication between the wellbore 26 and an inner space 31 of the perforating gun 28. Similar to the low pressure inner space 27 of the sealed chamber 24, a low pressure may also be trapped within the inner space 31 of the perforating gun 28. Alternatively, the perforating gun 28 includes separate devices (not depicted), such as the special charges 25, to open fluid communication between the wellbore 26 and the inner space 31.

The perforation gun system 10 also includes a pressure gauge 38 that records the pressure within the well bore 26 during the local dynamic under-balance operation. Although the pressure gauge 38 is preferably installed at the bottom of the perforation gun system 10, it may also be located at other places within the system 10. There may also be multiple gauges in the system 10. These gauges may be used to measure the pressure in the wellbore 26, the inner space 31 of the gun 28, or the inner space 27 of the sealed chamber 24.

The perforation gun system 10 described herein is just an example of many possible tool systems that may be used to generate the local dynamic under-balance condition. U.S. Pat. Nos. 6,598,682, 6,966,377, 7,121,340, and 7,182,138 assigned to Schlumberger, which are all herein incorporated in their entirety by reference, relate to various techniques that are capable to achieve a local dynamic under-balance condition.

Some embodiments of the methods disclosed herein may be performed in whole or in part through the use of a computer. Steps of embodiments may be performed by one or more dedicated use computers or processors or performed by computer programs or computer program modules stored on computer readable media and executed by a general purpose computer to carry out the steps and functions as disclosed herein. In these computer implemented embodiments, a technical effect of the presently disclosed system and method is to provide a more accurate estimation of well properties, formation properties, or transient pressure characteristics during a local dynamic under-balance condition.

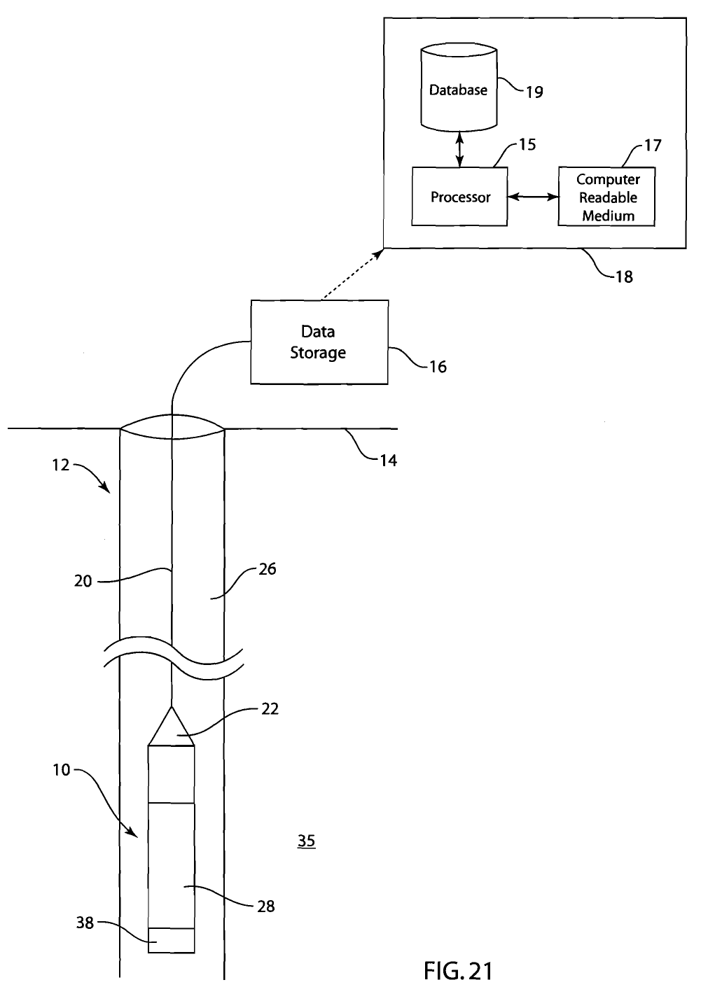

Referring to FIG. 21, in an embodiment that is implemented fully or partially through the use of a computer, the pressure gauge 38 of the tool system 10 measures the transient pressure in the wellbore 26 of a well 12. This transient pressure is recorded in a data storage device 16 that may be integrated with the tool system or located at the surface 14 of the well 12 and is communicatively connected to the tool system 10 through the adaptor 22 and a communicative connection such as a wireline 20. Alternatively the communicative connection may be another form of wired or wireless data connection. The data storage device 16 also stores data relating to the tool system 10 such as, but not limited to, the gun system parameters of the perforating gun 28.

Data from the data storage device 16 is communicated or transmitted to a computer 18 with a processor 15. The computer 18 may be a specific use well property estimation device, or a central processing unit of a general purpose computer. The processor 15 of the well property estimation device or the general purpose computer is coupled to a computer readable medium 17 upon which is stored computer readable code in the form of software program and/or program modules that provide the logical steps of embodiments of the method as disclosed herein. Upon execution of the computer readable code by the processor 15, the processor 15 obtains the recorded data from the data storage device 16 and performs the methods as disclosed herein. The processor 15 may further be coupled to a database 19 that includes a plurality of formulas, models, transformations, or correlations that are used in embodiments of the methods disclosed herein to provide the relationships and/or correlation between transient pressure characteristics and the well properties.

It is understood that embodiments of the data storage device 16, database 19, and computer readable medium 17 are not limiting on the structures by which these devices are able to communicate data to and from the processor 15. These communicative connections may be achieved in a variety of ways including through wired or wireless communication or by communication through a server or the Internet.

It is further noted that, formulas, models, transformations, or correlations stored in the database 19 may have been originally obtained through the analysis of aggregate transient pressure characteristic values and well property values as obtained from a variety of field local dynamic under-balance operations and/or laboratory experiments as disclosed in accordance with embodiments of the methods disclosed herein.

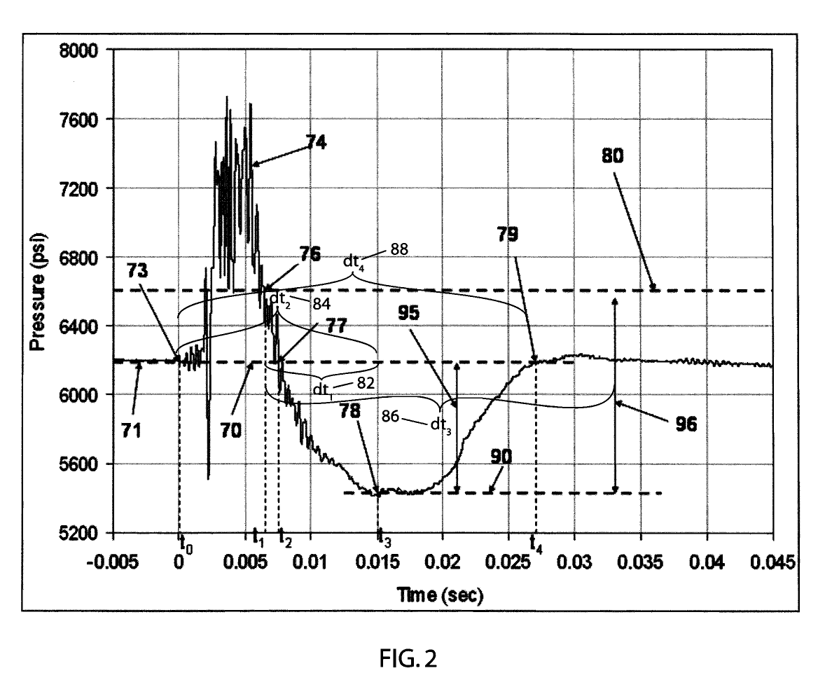

FIG. 2 is a graph depicting an example of a transient pressure history measured and recorded by the pressure gauge 38 during a local dynamic under-balance condition created by the perforation gun system 10.

Referring to FIGS. 1 and 2, before the local dynamic under-balance condition is generated, the wellbore pressure waveform 71 recorded by the pressure gauge 38 has an initial wellbore pressure 70. The local dynamic under-balance begins at time t₀, 72, when the perforating gun 28 is used to perforate the well casing 30 and cement sheath 34 to establish fluid communication between the formation 35 and wellbore 26 and/or an explosive material of device 25 opens the sealed chamber 24 to fluid communication with the wellbore 26. The pressure waveform 71 exhibits a large magnitude 74 with large noisy values in a short period of time after to due to these explosive forces. Because a low pressure trapped inside the inner space 27 of the sealed chamber 24 and/or the inner space 31 of perforating gun 28 is exposed to the wellbore 26, the pressure waveform 71 quickly decreases from the large magnitude 74. The reservoir pressure outside of the wellbore 26 is represented by magnitude 80. If the reservoir pressure 80 is larger than the initial wellbore pressure 70, the pressure waveform 71 will intercept the reservoir pressure 80 at time t₁, 76, and the initial wellbore pressure 70 at time t₂, 77. If the reservoir pressure 80 is equal to the initial pressure 70, the times t₁ and t₂ are the same. For a typical local dynamic under-balance operation performed by the perforation gun system 10, the pressure waveform 71 continues to decrease after t₂ and reaches a global minimum 90 at time t₃, 78. Then, the pressure waveform 71 recovers and reaches the value of the initial wellbore pressure 70 at time t₄, 79. After the time t₄, the pressure waveform 71 fluctuates before eventually reaching equilibrium with the reservoir pressure 80. The pressure waveform 71, as recorded by the pressure gauge 38, and the transient pressure characteristics in the waveform 71, may be used to evaluate the formation parameters of the surrounding formation 35.

The transient pressure characteristics of the pressure waveform 71 disclosed herein can be distinguished into three categories: time based, pressure based, and time and pressure based, although it is understood that other transient pressure characteristics may be obtained from pressure waveform 71 and similarly used as disclosed herein.

A first time characteristic (dt₁), 82, in the pressure waveform 71 is the time duration between the time t₁, at which the waveform 71 intercepts the reservoir pressure 80, and the time t₃, at which the global minimum value on the waveform 71 occurs:

dt₁=t₃−t₁ (1)

A second time characteristic (dt₂), 84, in the pressure waveform 71 is the time duration between the time t₀, at which the local dynamic under-balance condition is commenced and the time t₃, at which the global minimum value on the waveform 71 occurs:

dt₂=t₃−t₀ (2)

A third time characteristic (dt₃), 86, in the pressure waveform 71 is the time duration between the time t₁, at which the waveform 71 intercepts the reservoir pressure 80 and the time t₄, at which the pressure waveform 71 recovers to the initial wellbore pressure 70:

dt₃=t₄−t₁ (3)

A fourth time characteristic (dt₄), 88, in the pressure waveform 71 is the time duration between the time t₀, at which the local dynamic under-balance condition is commenced and the time t₄, at which the pressure waveform 71 recovers to the initial wellbore pressure 70:

dt₄=t₄−t₀ (4)

A first pressure characteristic (DUB₁), 96, in the pressure waveform 71 is the pressure difference between the reservoir pressure magnitude 80, or pᵣₑₛ, and the global minimum pressure 90:

DUB₁=pᵣₑₛ−p(t₃) (5)

A second pressure characteristic (DUB₂), 95, in the pressure waveform 71 is the pressure difference between the initial wellbore pressure 70, or p_{wb}, and the global minimum pressure 90:

DUB₂=p_{wb}−p(t₃) (6)

A first time and pressure based characteristic (Ω₁) in the pressure waveform 71 is the area formed by the reservoir pressure 80 and the pressure waveform 71 between the time t₁ and the time t₄, i.e.,

$${Ω}_{1} = {\int }_{{t}_{1}}^{{t}_{4}} ( {p}_{res} - p ( t ) ) d t \qquad ( 7 )$$

A second time and pressure based characteristic (Ω₂) in the pressure waveform 71 is the area formed by the initial wellbore pressure 70 and the pressure waveform 71 between the time t₂ and the time t₄:

$${Ω}_{2} = {\int }_{{t}_{2}}^{{t}_{4}} ( {p}_{wb} - p ( t ) ) d t \qquad ( 8 )$$

The characteristic properties dt₂, dt₄, DUB₂ and Ω₂ can be obtained directly from the pressure waveform 71 recorded during the local dynamic under-balance while dt₁, dt₃, DUB₁, and Ω₁ require the value of the reservoir pressure. It is contemplated that many other transient pressure characteristics may be obtained from the pressure waveform 71 and similarly used in the methods described herein.

The transient pressure characteristics of the pressure waveform 71 for the local dynamic under-balance operation depend on a variety of well properties, including: wellbore, formation, and perforation gun system parameters.

The wellbore parameters include, but are not limited to, the following:

Initial wellbore pressure;

Well casing inside diameter;

Wellbore fluid density (weight);

Wellbore fluid compressibility; and

Wellbore fluid viscosity.

The formation parameters include, but are not limited to, the following:

Reservoir pressure;

Formation permeability;

Formation porosity;

Formation transmissibility;

Formation mobility;

Near perforating tunnel formation damage (skin factor);

Formation fluid viscosity; and

Formation fluid density (weight).

The gun system parameters include, but are not limited to, the following:

Conventional charges used in the perforating;

Special charges used on the low-pressure sealed chamber;

Shots per foot of the conventional charges;

Shots per foot of the special charges;

Explosive mass of a conventional charge;

Explosive mass of a special charge;

Gun outside diameter;

Gun and surge chamber lengths;

Surge chamber length;

Perforated (or charge loading) length on gun;

Phasing of the shots;

Free gun volume;

Perforated hole diameter; and

Total opening area on the gun.

The parameters given above have been identified as factors that affect the transient pressure during a local dynamic under-balance. Other parameters, for example, well deviation and well depth, etc. may also affect the transient pressure and could also be included in the methods disclosed herein. Also, some parameters in the above list can be replaced by new parameters that are combinations of the parameters in the above lists. For example, if Δp=pᵣₑₛ−p_{wb}, then Δp can replace either pᵣₑₛ or p_{wb} in the analysis with similar results. Therefore, many parameter sets, which may contain different number of parameters, can be used.

The evaluation of the formation properties from the measured pressure waveform 71, requires that transient pressure characteristics dt₁, dt₂, dt₃, dt₄, DUB₁, DUB₂, Ω₁ and Ω₂ are first correlated to all or some of the well properties. This may be empirically done using the well properties and transient pressure characteristics obtained from a plurality of field jobs and/or laboratory experiments. A variety of regression techniques can be used for this purpose. One technique that may be used is the non-parametric regression method presented by Friedman and Stuetzle in “Projection pursuit regression,” Journal of American Statistical Association, Vol. 76, pp. 817-823, 1981, and the technique presented by Breiman and Friedman in “Estimating optional transformations for multiple regression and correlation,” Journal of American Statistical Association, Vol. 80, pp. 580-598, 1985, both of which are hereby incorporated by reference in their entireties. Alternatively, these regression based correlations may be replaced by mathematical models.

In the embodiment disclosed below applying a selected regression technique, Y is a dependent variable that represents one of the transient pressure characteristics dt₁, dt₂, dt₃, dt₄, DUB₁, DUB₂, Ω₁ and Ω₂, and n is the number of well properties, including wellbore, formation, and gun system parameters given above. The series X₁, X₂, . . . , Xₙ represents the well properties as the independent variables.

If θ(Y), ψ₁(X₁), ψ₂(X₂), . . . , ψₙ(Xₙ) are the arbitrary measurable mean-zero transformations of the original variables Y, X₁, X₂, . . . , Xₙ, the error variance e² of the regression is expressed by

$${e}^{2} ( θ , {ψ}_{1} , {ψ}_{2} , Λ , {ψ}_{n} ) = \frac{E \{ {[ θ ( Y ) - {\sum }_{i = 1}^{n} {ψ}_{i} ( {X}_{i} ) ]}^{2} \}}{E [ {θ}^{2} ( Y ) ]} \qquad ( 9 )$$

Here E represents the expectation operator. The non-parametric regression technique minimizes e² to find the optimal transformations θ*(Y), ψ*₁(X₁), ψ*₂(X₂), . . . , ψ*ₙ(Xₙ) such that

e²(θ*, ψ*₁, ψ*₂, Λ, ψ*ₙ)=min[e²(θ, ψ₁, ψ₂, Λ, ψₙ)] (10)

When the optimal transformations θ*(Y), ψ*₁(X₁), ψ*₂(X₂), . . . , ψ*ₙ(Xₙ) are obtained and a new observation k of the independent variables are known as X₁ₖ, X₂ₖ, . . . , Xₙₖ, the dependent variable Yₖ corresponding to the new observation k can be calculated by

$${Y}_{k} = {( {θ}^{*} )}^{- 1} [ {\sum }_{i = 1}^{n} {ψ}_{i}^{*} ( {X}_{ik} ) ] \qquad ( 11 )$$

Here (θ*)⁻¹ is the backward transformation of θ*. Inversely, when the dependent variable Yₖ and all independent variables X₁, X₂, . . . , Xⱼ₋₁, X_{j+1 . . .} , Xₙ are known except for a single unknown well property Xⱼ the unknown well property Xⱼ in the new observation k can be calculated by

$${X}_{jk} = {( {ψ}_{j}^{*} )}^{- 1} [ [ {θ}^{*} ( {Y}_{k} ) ] - {\sum }_{i = 1 , i \neq j}^{n} {ψ}_{i}^{*} ( {X}_{ik} ) ] \qquad ( 12 )$$

In an alternative to the above non-parametric regression technique, conventional multiple variable regression methods can also be used to establish the functional forms between the dependent variable Y (the transient pressure characteristics dt₁, dt₂, dt₃, dt₄, DUB₁, DUB₂, Ω₁ and Ω₂) and the independent variables Xᵢ (wellbore, formation and gun system parameters). The functional forms can be expressed by

Y=F(X₁, X₂, Λ, Xₙ) (13)

When the independent variables X₁ₖ, X₂ₖ, . . . , Xₙₖ for a new observation k are known and the functional form of the correlation F is obtained, the dependent variable Yₖ can be calculated by:

Yₖ=F(X₁ₖ, X₂ₖ, Λ, Xₙₖ) (14)

Formula (14) is the conventional regression method equivalent to the non-parametric regression formula (11). Similarly, if the functional form F, the dependent variable Yₖ, and all independent variables X₁, X₂, . . . , Xⱼ₋₁, X_{j+1 . . .} , Xₙ except Xⱼ for a particular observation k are known, Xⱼ can be calculated by

Xⱼₖ=F⁻¹(Yₖ, X₁ₖ, X₂ₖ, Λ, Xⱼ₋₁ₖ, Xⱼ₊₁ₖ, Λ, Xₙₖ) (15)

Here F⁻¹ is the backward transformation of the functional form F. Formula (15) is the conventional regression method equivalent to the non-parametric regression formula (12). One of the major drawbacks of the conventional regression technique used to calculate Xⱼ from (15) is that the backward transformation F⁻¹ is often difficult to find or requires root searching if Xⱼ has a nonlinear form in F. For the non-parametric regression technique, once the optimal transformations are obtained, estimating the independent variable Xⱼ from (12) is straightforward. The reason is that Xⱼ has the unique transformation ψ*ⱼ and the backward transformation (ψ*ⱼ)⁻¹ is simply obtained from the backward interpolation through ψ*ⱼ. This feature will be clearer from an example given later.

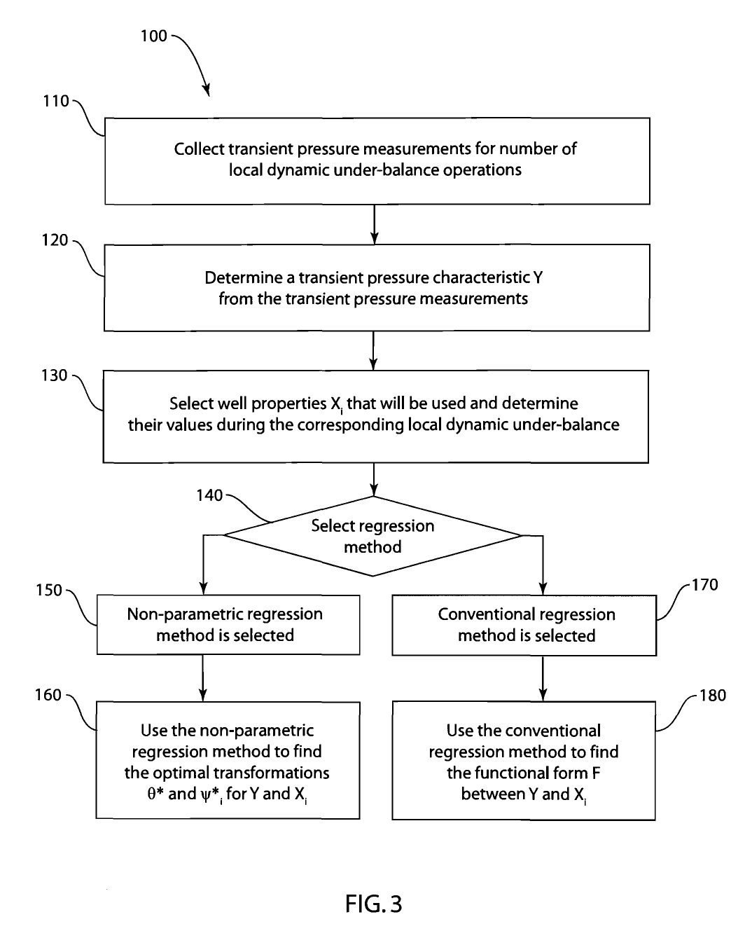

FIG. 3 is a flow chart representing an embodiment of a method 100 that is used to obtain the relationships between the dependent variable Y (one of the transient pressure characteristics) and the independent variables Xᵢ, i=1, . . . , n (the well properties selected from wellbore, formation, and gun system parameters).

First the transient pressure measurements are collected in step 110 from a plurality of local dynamic under-balance conditions. These measurements may be obtained from either field operations, laboratory experiments, or both field operations and laboratory experiments.

Next, at step 120, the value of a characteristic Y (i.e. one of dt₁, dt₂, dt₃, dt₄, DUB₁, DUB₂, Ω₁ and Ω₂) is determined from the transient pressure measurements collected in step 110.

Then, at step 130, the well properties are selected. These well properties may include wellbore, formation and gun system parameters Xᵢ (i=1, . . . n) that will be used to construct the relationships between the dependent variable Y and the independent variables Xᵢ. These well properties are primarily selected from the properties in the previous lists and/or their derivatives. However, other well properties that are not given may also be used. This is because different local dynamic under-balance operations may have different well properties with large influences. Nevertheless, the methods and procedures disclosed herein to construct the relationships between the dependent and independent variables do not change even if the selected independent well properties Xᵢ are different. The values of the selected well properties Xᵢ are determined for each local dynamic under-balance operations, such that a plurality of data sets comprising well property values Xᵢ(i=1, . . . , n) and a transient pressure characteristic value Y are created for each local dynamic under-balance condition.

Next, at step 140, a regression method is selected. If the non-parametric regression method is selected 150, the optimal transformations θ* and ψ*ᵢ corresponding to the independent variable Y and dependent variables Xᵢ are obtained at step 160. If the conventional regression method is selected 170, the functional form F between Y and Xᵢ is obtained at step 180.

The method 100 may be applied to the data from a plurality of local dynamic under-balance operations. In one embodiment, the method 100 is applied to one hundred sixty-eight local dynamic under-balance operations to obtain correlations between a selected transient pressure characteristic Y and a set of selected well properties Xᵢ.

For ease of explanation, the exemplary transient pressure characteristic of the fourth time characteristic (dt₄) will be used throughout the description herein. However, it is understood that any of the other disclosed or undisclosed transient pressure characteristics may be used similarly to the fourth time characteristic (dt₄) within the scope of the present disclosure. The duration of the local dynamic under-balance condition (dt₄) is chosen as the dependent variable Y. An exemplary set of thirteen independent variables Xᵢ are selected from the well property lists of the wellbore, formation, and gun system parameters. From the index i=1 to 13, these parameters Xᵢ are:

(1) the initial wellbore pressure before detonation of perforating guns;

(2) number of special charges;

(3) number of the conventional charges;

(4) casing ID;

(5) gun OD;

(6) explosive mass per conventional charge;

(7) gun length;

(8) perforated length;

(9) formation permeability;

(10) total free volume inside the gun;

(11) total open area on the gun;

(12) wellbore fluid density; and

(13) the pressure difference between reservoir pressure and the initial wellbore pressure (delta P).

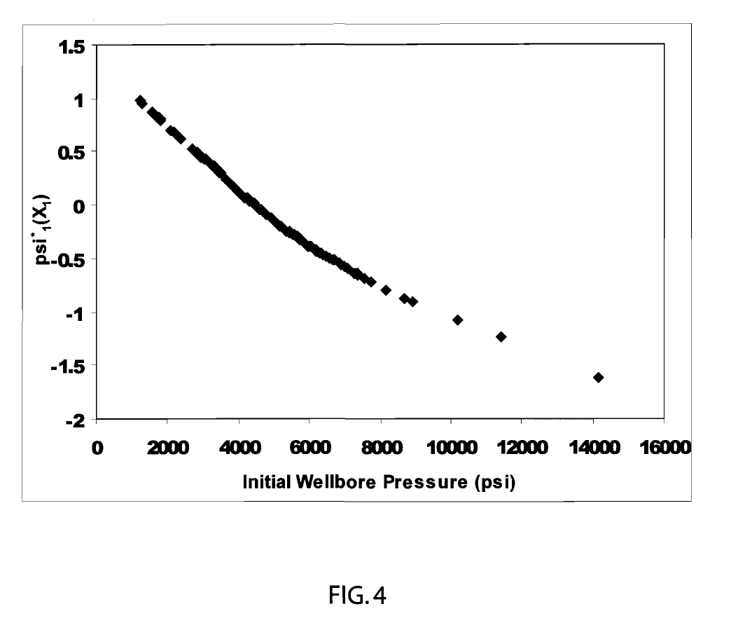

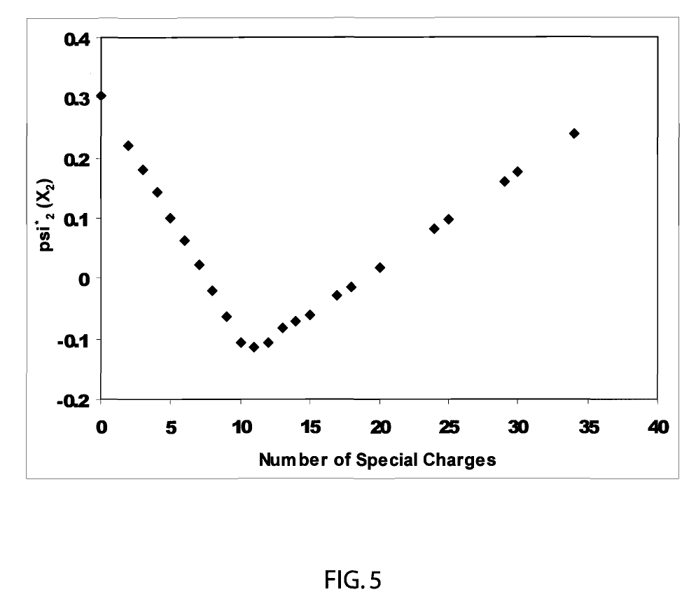

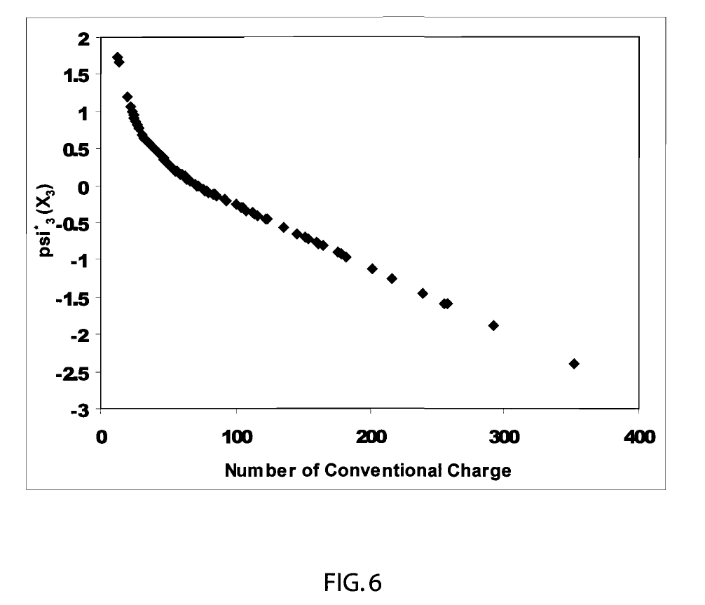

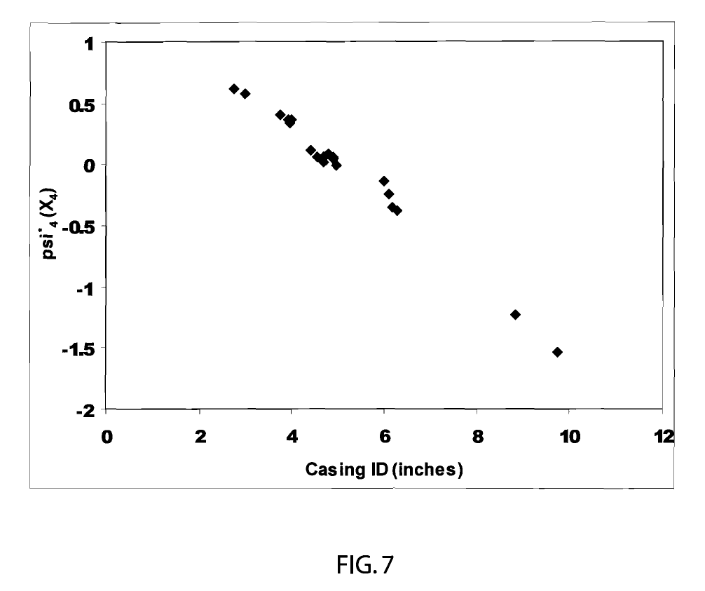

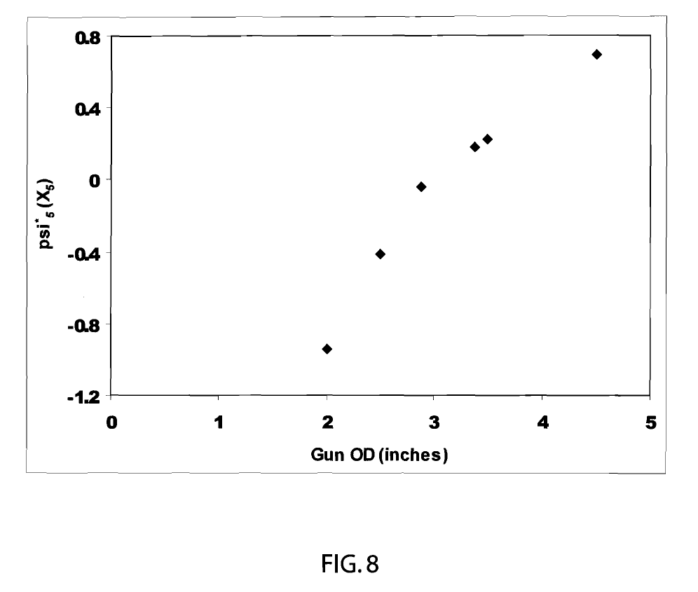

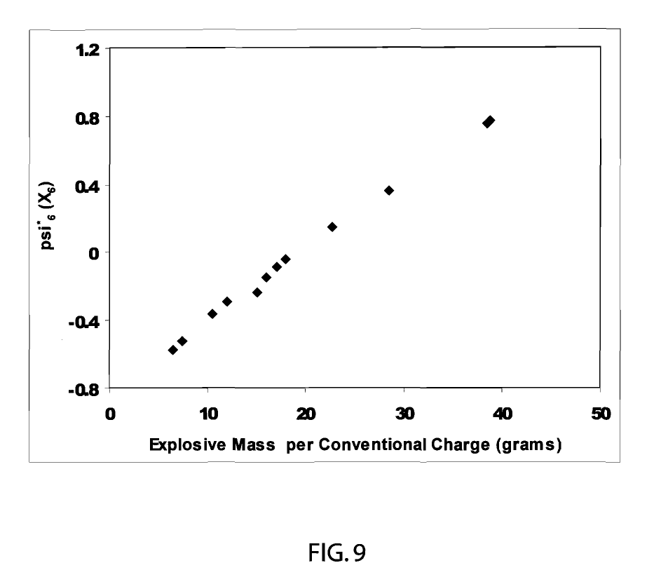

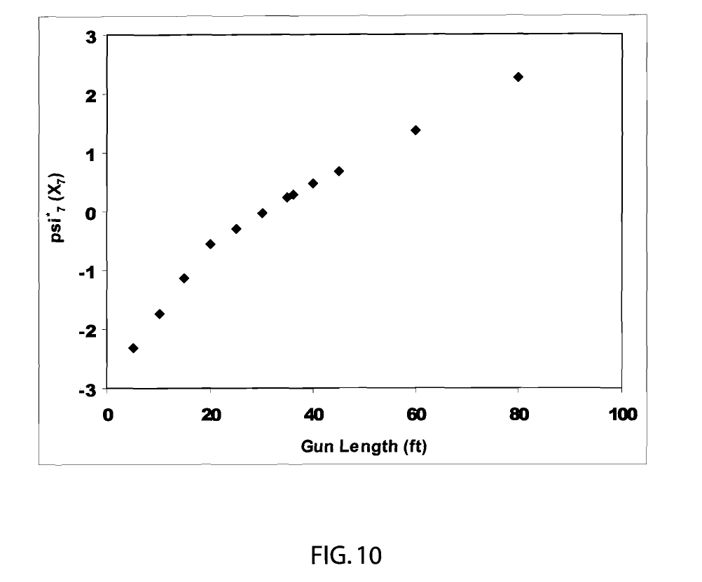

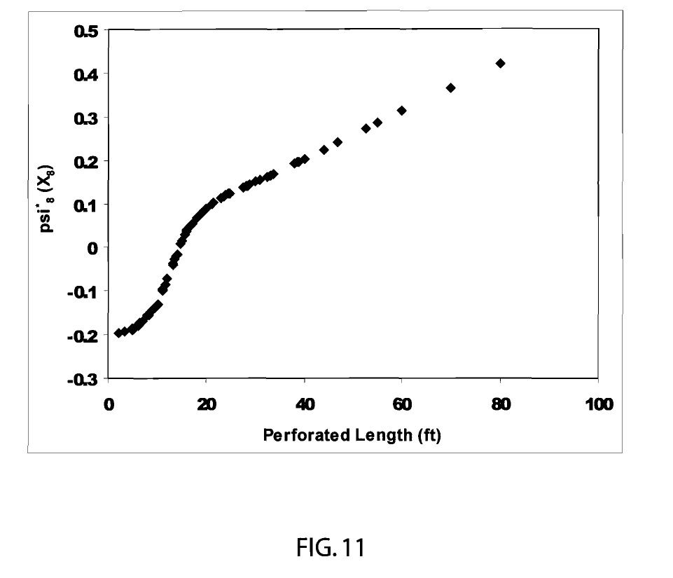

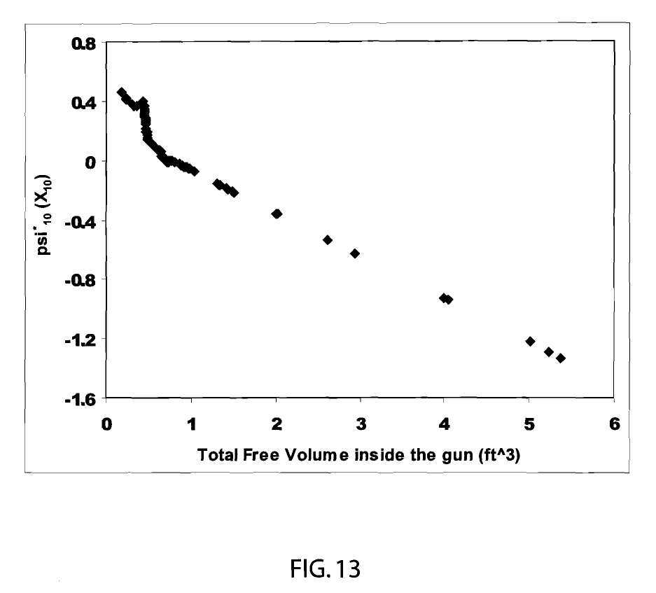

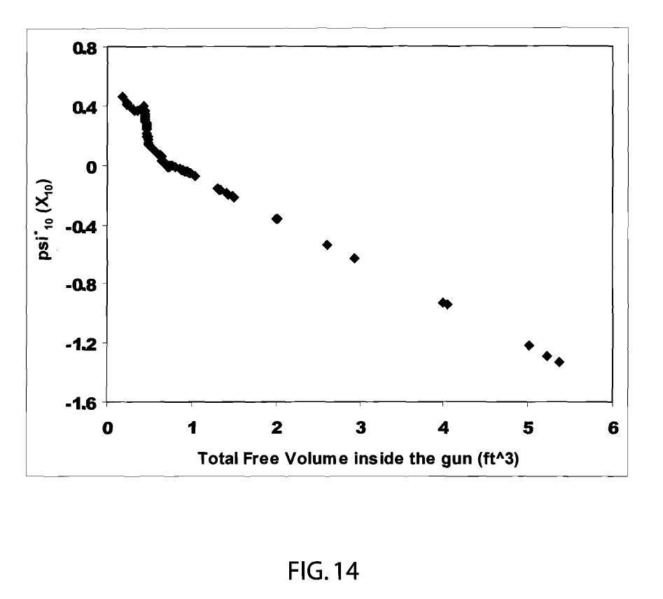

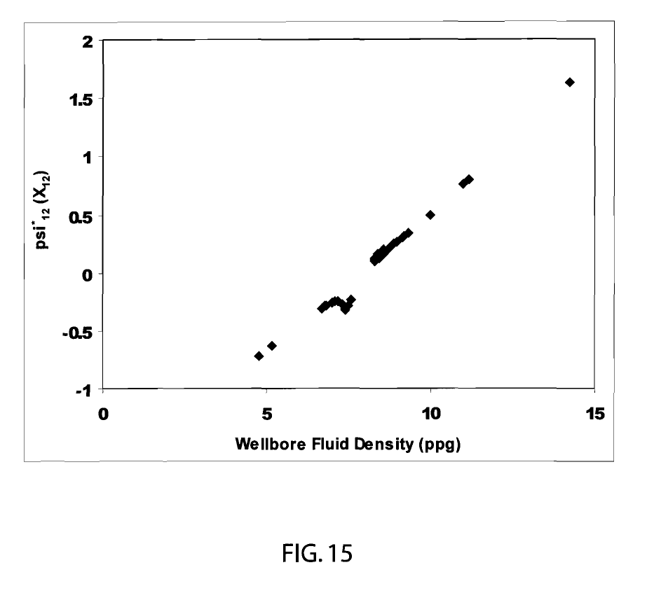

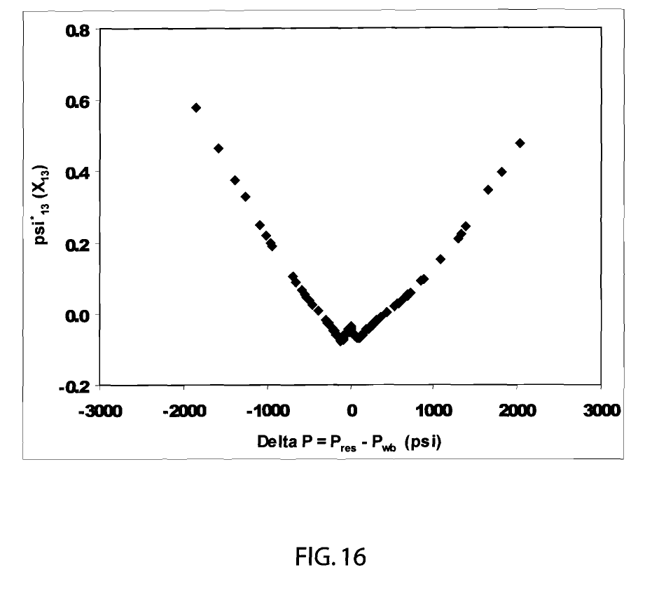

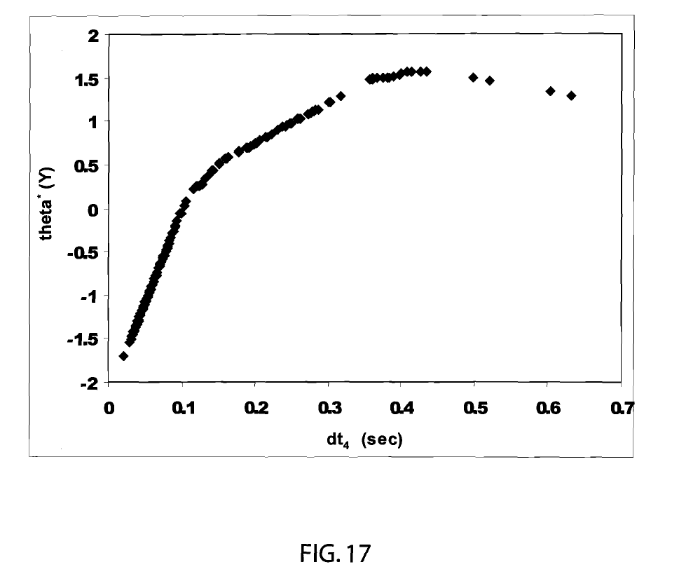

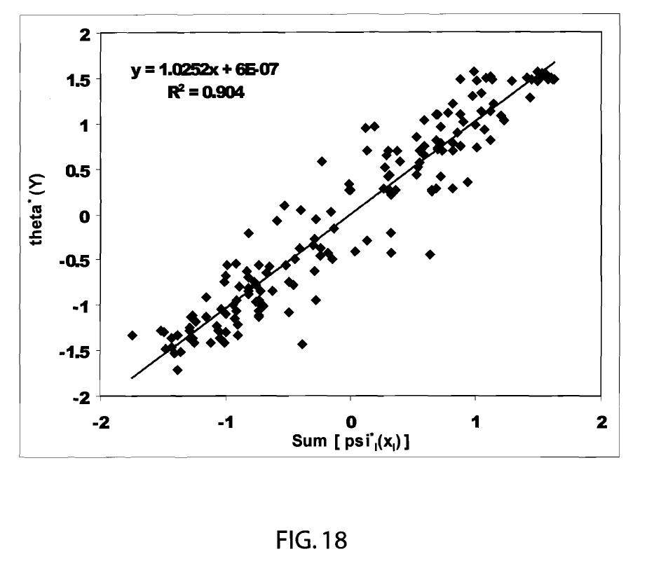

FIGS. 4-16 show exemplary transformations ψ*ᵢ for the corresponding independent variables Xᵢ. FIG. 17 shows an exemplary transformation θ* for the fourth time characteristic dt₄, or the dependent variable Y. Finally, FIG. 18 shows the correlation between the summation of all of the transformed independent variables ψ*ᵢ(Xᵢ), and θ*(Y) (the transformed dependent variable Y). It can be seen that in this example an excellent correlation coefficient R²=0.904 has been obtained. This correlation establishes the relationship between the original dependent variable fourth time characteristic (dt₄) and the summation of the transformed values of the thirteen independent variables Xᵢ. Similar transformations for any of the other dependent variables dt₁, dt₂, dt₃, DUB₁, DUB₂, Ω₁, and Ω₂ etc can also be obtained using these same procedures.

Note that if the number of observations was not one hundred sixty-eight, or some observations were replaced by other measurements, the transformations and final correlation would be changed. Nevertheless, if the observations are sufficient and representative, all related final results should be similar to those shown in FIGS. 4-18.

It should also be pointed out that although the thirteen parameters used in the regression form the exemplary set of well properties, other well properties and other sets of well properties comprising different numbers of well properties might also be used in embodiments. In this situation, the transformations might be different for the different well properties used in the estimation. However, if the selected well properties are sufficiently correlated to the transient pressure and formation properties, the obtained transformations and correlation will exhibit a similar quality of correlation.

After the optimal transformations ψ*ᵢ and θ* have been obtained as described above, they can be used to predict a selected transient pressure characteristic (dt₁, dt₂, dt₃, dt₄, DUB₁, DUB₂, Ω₁ and Ω₂) in the transient pressure measurements for a future local dynamic under-balance operation. This application may be used to design or evaluate a local dynamic under-balance operation before it is performed. Estimating the values of transient pressure characteristics before local dynamic under-balance operation is important for a high quality and safe job execution. For example, if DUB₁ or DUB₂ is too large, the local dynamic under-balance may induce a formation collapse and generate too much debris in the wellbore. Inversely, if DUB₁ or DUB₂ projected to be too small, the operation may not be able to provide a desired quality of perforating tunnel clean-up.

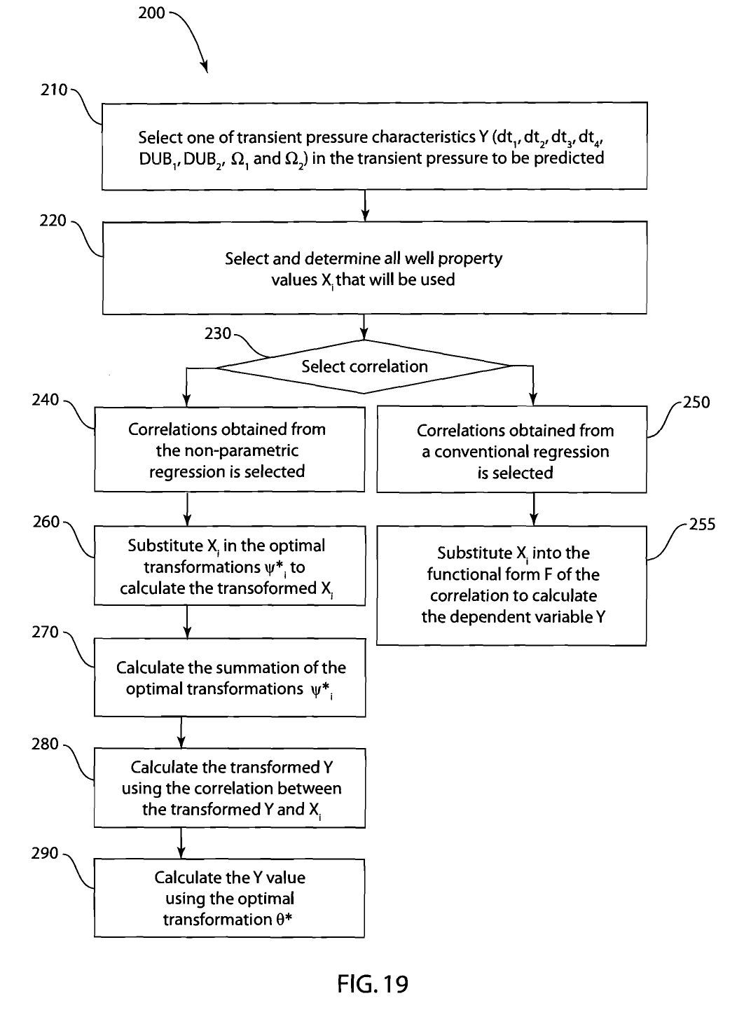

FIG. 19 is a flow chart depicting the steps of an embodiment of a method 200 of predicting a selected transient pressure characteristic (dt₁, dt₂, dt₃, dt₄, DUB₁, DUB₂, Ω₁ and Ω₂) in a future local dynamic under-balance operation.

In brief, the method 200 includes selecting a transient pressure characteristic 210. The transient pressure characteristic selected in step 210 is designated as the Y value and may be selected from the transient pressure characteristics dt₁, dt₂, dt₃, dt₄, DUB₁, DUB₂, Ω₁ and Ω₂, or any other suitable transient pressure characteristics. This is the transient pressure characteristic of the future local dynamic under-balance operation that is to be predicted.

Next, the well property values Xᵢ that will be used in the estimation are selected and determined at step 220. The selected well property values are all known values that represent the future local dynamic under-balance operation.

Then, a correlation method is selected in step 230. This selection may be made between a non-parametric regression technique 240 or a conventional regression technique 250. If the non-parametric regression technique is selected, the known values for the well properties Xᵢ are substituted into the known optimal transformations Ψ*ᵢ (e.x. FIGS. 4-16) to calculate the transformed Xᵢ values, Ψ*ᵢ (Xᵢ). Note that the optimal transformation Ψ*ᵢ must be obtained using the same set of well properties from the existing local dynamic under-balance operation data, or representative lab data, as the set of well properties (Xᵢ) used in the present estimation. For example, if the optimal transformations of Ψ*₁ and Ψ*₂ are obtained using only two parameters (i.e. the initial wellbore pressure and the number of conventional charges) for the correlation of the fourth time characteristic (dt₄), then predicting the fourth time characteristic (dt₄) with the correlation for a future operation should use the initial wellbore pressure and the number of conventional charges as the two independent variables (X₁, X₂) and the corresponding optimal transformations Ψ*₁ and Ψ*₂.

Next, at step 270, the summation of the optimal transformations Ψ*ᵢ is calculated. It exemplarily may be calculated by the equation:

$${\sum }_{i = 1}^{n} {ψ}_{i}^{*} ( {X}_{ik} ) \qquad ( 16 )$$

Then at step 280, the transformed Y value θ*(Y) is calculated using the correlation between θ* and the summation of the Ψ*ᵢ values calculated in step 270. This correlation is exemplarily represented in FIG. 18.

Finally, at step 290, the value of the selected transient pressure characteristic Y is calculated using the optimal transformation of θ* with the selected transient pressure characteristic. This transformation is exemplarily shown at FIG. 17.

Alternatively, in step 230, it may be selected that the correlations are obtained from a conventional regression 250. If it is selected that the correlations are obtained from a conventional regression, then in step 255 the Xᵢ values are substituted into the functional form F of the computed correlation in order to calculate the selected transient pressure characteristic Y.

To demonstrate the application of the embodiment of the method in FIG. 19 in the prediction of a transient pressure characteristic of a local dynamic under-balance operation, the following example is given below. Assume that the fourth time characteristic (dt₄) is the transient pressure characteristic selected in step 210 to be determined. The thirteen parameters represented in FIG. 4-16 are selected in step 220 to be the independent variables of the well properties. These values are known such that:

(1) The initial pressure is 6000 psi;

(2) 10 special charges;

(3) 100 conventional charges;

(4) casing ID is 4 in.;

(5) gun OD is 2.5 in.;

(6) 10 grams explosive mass per conventional charge;

(7) gun length of 40 ft;

(8) perforated length of 20 ft;

(9) 1000 md permeability;

(10) free volume inside the gun 0.5 ft³;

(11) perforated hole area on gun is 0.05 ft²;

(12) wellbore fluid density of 10 ppg;

(13) 0 psi delta P.

The transformed values of these well properties are obtained in step 260 from the corresponding transformations depicted in FIGS. 4-16. Using the transformations in FIGS. 4-16, the approximate values of Xᵢ are −0.5, −0.12, −0.5, 0.0, −0.4, −0.4, 0.5, 0.1, −0.2, 0.0, 0.0, 0.5, 0.05 for the transformed parameters (1) to (13), respectively. These transformed

values are summed in step 270 using the equation

$${\sum }_{i = 1}^{13} {ψ}_{i}^{*} ( {X}_{ik} )$$

to produce a summation value of −0.97. Then, in step 280, the correlation shown in FIG. 18, is used to calculate the transformed fourth time characteristic (dt₄) value

$${θ}^{*} ( {dt}_{4 k} ) = 1.0252 {\sum }_{i = 1}^{13} {ψ}_{i}^{*} ( {X}_{ik} ) + 6 \times {10}^{- 7} \qquad ( 17 )$$

The Xᵢ transformation summation value −0.97 is substituted into equation (17), and the transformed θ*(dt₄ₖ) is calculated to be approximately −1.0. Finally, in step 290, the fourth time characteristic (dt₄) is estimated by using the θ*(dt₄ₖ) value in the dt₄ transformation represented in FIG. 17. The fourth time characteristic (dt₄) is estimated to be about 0.06 seconds.

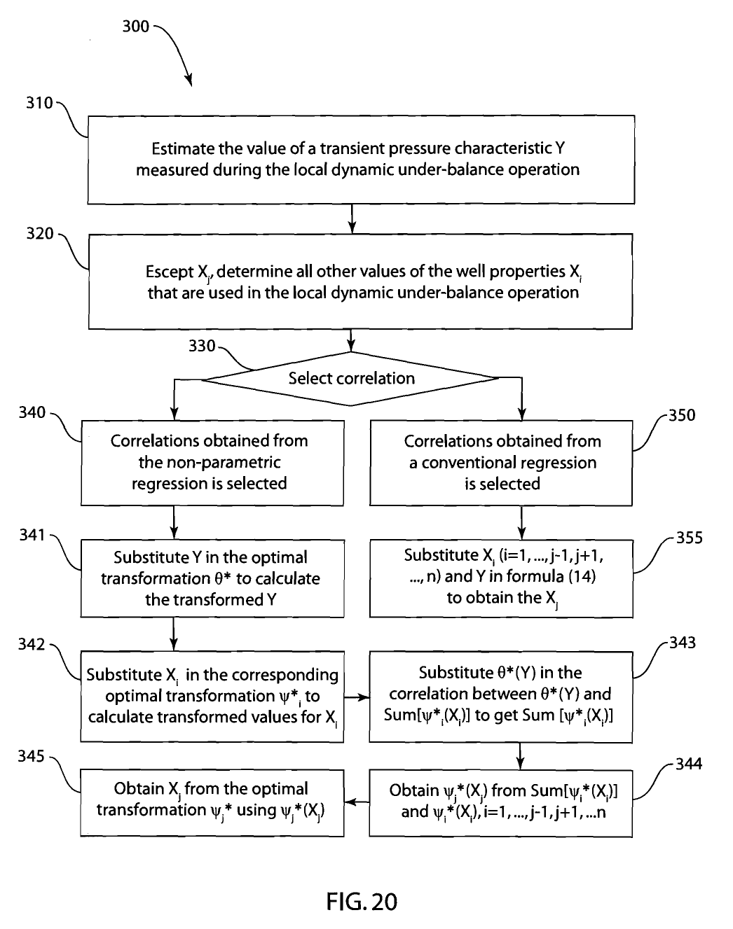

FIG. 20 depicts an embodiment of a further method 300 of estimating an unknown well property Xⱼ from among a set of well properties X(i, . . . ,j−1,j,j+1 . . . n) using a measured transient pressure characteristic and the previously obtained optimal transformations. This embodiment of the method 300 may be used when a formation property (for example, permeability, transmissibility, or mobility) is not known but will be estimated after a local dynamic under-balance operation is conducted. This method 300 requires that the formation property to be estimated is included in the well property set obtained by the method 100 in FIG. 3 using the data from existing dynamic under-balance operations to calculate the optimal transformation of Xᵢ and Y.

In brief, the method 300 includes selecting a transient pressure characteristic and estimating the value of the selected transient pressure characteristic 310 from a transient pressure measurement obtained during a local dynamic under-balance operation. Next, at step 320, all of the values of the known well properties Xᵢ in the set of well properties used to calculate the well property transformations are determined by the values of these well properties that were used in the local dynamic under-balance operation. These known well property values Xᵢ provide values for each of the well properties in the set except for the unknown well property Xⱼ that is to be estimated in the present method.

Then, at step 330, a correlation method is selected from between a non-parametric regression 340 and a conventional regression 350 for estimating the value of the unknown well property Xⱼ.

If the non-parametric regression 340 is selected, then in step 341 the transient pressure characteristic Y from step 310 is substituted into the optimal transformation θ* to calculate a transformed value for the transient pressure characteristic θ*(Yₖ). This optimal transformation θ* is exemplarily represented by FIG. 17.

Then, at step 342, the known values for the well properties Xᵢ(i=1 . . . j−1,j+1, . . . n) are substituted into the corresponding optimal transformations Ψ*ᵢ(i=1 . . . j−1,j+1, . . . n) to obtain the Ψ*ᵢ(Xᵢₖ) (i=1 . . . j−1,j+1 . . . n).

Next, at step 343, the transformed values for the known well properties Xᵢ are summed to obtain a summation of the transformed known well property values.

$${ψ}_{i}^{*} ( {X}_{ik} ) ( i = 1 … j - 1 , j + 1 , … n ) = {\sum }_{i = 1 , i \neq j}^{n} {ψ}_{i}^{*} ( {X}_{ik} ) \qquad ( 18 )$$

The transformed value of the transient pressure characteristic is used in combination with the correlation between the transformed transient pressure characteristic and the sum of the transformed

set of all well properties

$${\sum }_{i = 1}^{n} {ψ}_{i}^{*} ( {X}_{ik} )$$

to obtain a sum of the transformed set of all well property values. This is exemplarily presented in FIG. 18.

At step 344, the transformed value of the unknown well property Xⱼ is obtained by subtracting the sum of the transformed known well property values from the sum of the transformed set of all well property values to obtain the single transformed value of the unknown well property Xⱼ. This is represented by the equation:

$${ψ}_{j}^{*} ( {X}_{jk} ) = {\sum }_{i = 1}^{n} {ψ}_{i}^{*} ( {X}_{ik} ) - {\sum }_{i = 1 , i \neq j}^{n} {ψ}_{i}^{*} ( {X}_{ik} ) \qquad ( 19 )$$

Finally, at step 345, the unknown well property Xⱼ is obtained by applying Ψ*ⱼ(Xⱼₖ) to the optimal transformation by Ψ*ⱼ.

Alternatively, if the conventional regression 350 is selected at step 330, then in step 355 the value Xᵢ(i=1, . . . ,j−1,j+1 . . . n) and Y in formula (15) to obtain the Xⱼ value.

The following example demonstrates an application of the embodiment of the method 300 depicted in FIG. 20 to estimate a formation property using a transient pressure measurement obtained during a local dynamic under-balance operation. First, at step 310, the fourth time characteristic (dt₄) is selected to be the transient pressure characteristic (Y). After the local dynamic under-balance operation is performed and the transient pressure measured, the fourth time characteristic dt₄ is 0.06 sec., i.e, the transient pressure characteristic Yₖ=0.06. Here, k denotes the index of the dynamic under-balance operation. Next, at step 320, permeability is exemplarily selected as the formation property to be estimated in the present method and the transformations and correlations shown in FIGS. 4-18 can be used in the formation property estimation for the performed dynamic under-balance operation. This means that the formation property of permeability was included in the set of well properties used to calculate the transformations and correlations of FIGS. 4-18. In the example, X₉ is the parameter to be estimated (permeability) among the independent variables Xᵢ (i=1, 2, . . . 13). All other twelve well properties Xᵢ(i=1 . . . 8, 10, . . . 13) are known from the conducted local dynamic under-balance operation and have the same values as in the previous example:

(1) The initial pressure is 6000 psi;

(2) 10 special charges;

(3) 100 conventional charges;

(4) casing ID is 4 in.;

(5) gun OD is 2.5 in.;

(6) 10 grams explosive mass per conventional charge;

(7) gun length of 40 ft;

(8) perforated length of 20 ft;

(9) unknown formation permeability;

(10) free volume inside the gun 0.5 ft³;

(11) perforated hole area on gun is 0.05 ft²;

(12) wellbore fluid density of 10 ppg;

(13) 0 psi delta P.

In step 341, the transformation represented by FIG. 17 is used to estimate a transformed value for the fourth time characteristic (dt₄), or θ*(Yₖ). Based on the transformation of FIG. 17 since Yₖ=0.06, θ*(Yₖ)≈−1.0.

In step 342, the transformations ψᵢ (1-8, 10-13), represented in FIGS. 4-11, 13-16, are used in combination with the twelve known well property values to calculate the transformed values ψ*₁(X₁ₖ), ψ*₂(X₂ₖ), . . . , ψ*₈(X₈ₖ), ψ*₁₀(X₁₀ₖ), . . . , ψ*₁₃(X₁₃ₖ) of the known well property values. The calculated transformed known well property values are: −0.5, −0.12, −0.5, 0., −0.4, −0.4, 0.5, 0.1, 0., 0., 0.5, 0.05, respectively.

In step 343, the twelve transformed values are summed,

$${\sum }_{i = 1 , i \neq 9}^{13} {ψ}_{i}^{*} ( {X}_{ik} ) ,$$

for a transformed known well property value summation of −0.77. The transformed transient pressure characteristic, θ*(Yₖ)=−1.0, is substituted into the correlation shown in FIG. 18 and given in expression (17) to obtain the summation of all transformed values of the set
of well property values,

$${\sum }_{i = 1}^{13} {ψ}_{i}^{*} ( {X}_{ik} ) .$$

This summation is calculated to be −0.975.

The transformed permeability value ψ*₉(X₉ₖ) is calculated in step 344, by subtracting the summation of the transformed known well property values from the summation of the set of well property values:

$${ψ}_{9}^{*} ( {X}_{9 k} ) = {\sum }_{i = 1}^{13} {ψ}_{i}^{*} ( {X}_{ik} ) - {\sum }_{i = 1 , i \neq 9}^{13} {ψ}_{i}^{*} ( {X}_{ik} ) \qquad ( 20 )$$

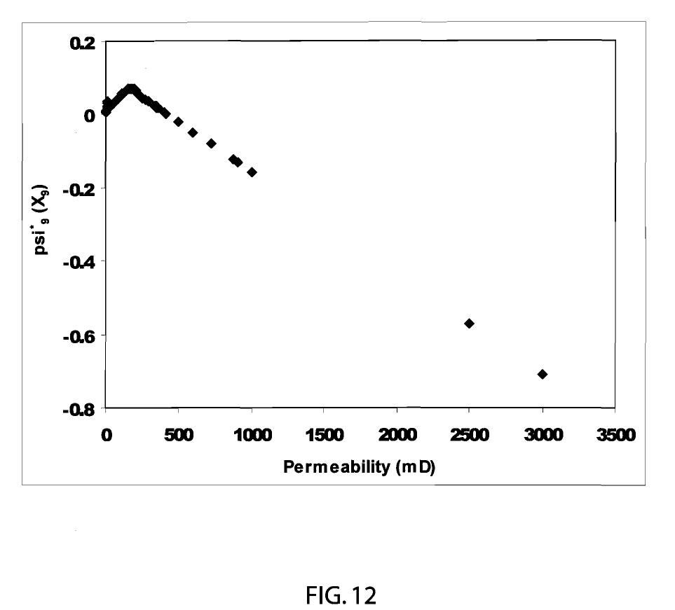

This expression calculates the transformed permeability value to be 0.205 (ψ*₉(X₉ₖ)=−0.975+0.77=−0.205). Finally, at step 345, the permeability is estimated to be about 1000 md, using the transformed permeability value (−0.205) with the permeability transformation exemplarily depicted in FIG. 12.

This evaluation method for estimating an unknown well property Xⱼ applies to all correlations corresponding to different transient pressure characteristics Y. For example, using the fourth time characteristic dt₄ value and the twelve known well properties in the previous example, the permeability can be estimated from the method with the optimal transformations shown in FIGS. 4-18. Similar analyses can be performed using other transient pressure characteristics (dt₁, dt₂, dt₃, DUB₁, DUB₂, Ω₁ or Ω₂) as these characteristics can also be used to develop the different optimal transformations and correlations similar to those embodied in FIGS. 4-18. If the permeability is also one of the independent variables used in these correlations, the corresponding transformations can also be utilized to estimate the permeability.

In an embodiment wherein multiple estimations for the unknown well property Xⱼ are produced by performing the method 300 using different starting transient pressure characteristics (dt₁, dt₂, dt₃, dt₄, DUB₁, DUB₂, Ω₁ or Ω₂), each new application of the method 300 may provide a slightly different estimated value for the unknown well property Xⱼ. The final value of the unknown well property Xⱼ can be either the average of all the estimated Xⱼ values provided by the different correlations corresponding to different characteristics Y or another form of reconciliation may be used to obtain a final value for Xⱼ.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various alternatives and embodiments are contemplated as being within the scope of the following claims particularly pointing out and distinctly claiming the subject matter regarded as the invention.

What is claimed is:

1. A computer implemented method of estimating an unknown well property value of a hydrocarbon reservoir from a set of well property values stored on a data storage device wherein a processor is coupled with a computer readable medium, the computer readable medium including a set of computer readable code, further wherein the processor executes the computer readable code, thus effectuating the following method, the method comprising:
establishing a data value representative of the unknown well property value, the data value being stored on a data storage device;
establishing a transient pressure characteristic value and storing the data value on the data storage device;
determining at least one known well property value in the set of well property values stored on the data storage device;
correlating the transient pressure characteristic with the at least one known well property value;
transforming the data value by obtaining an unknown well property correlation value from the correlation of the transient pressure characteristic and the at least one known well property value and estimating the unknown well property value from the unknown well property correlation value;
storing the transformed data value representative of the estimated unknown well property value on the data storage device; and
presenting the estimated unknown well property value on a graphical display.

2. The method of claim 1 wherein correlating the transient pressure characteristic with the at least one known well property value further comprises the steps of:
obtaining a characteristic transform from a database including a plurality of characteristic transforms;
applying the transient pressure characteristic to the characteristic transform to obtain a transformed characteristic value;
obtaining a transformed known well property value for each of the at least one known well property value; and
calculating the unknown well property correlation value from the transformed characteristic value and the at least one transformed known well property value, wherein the unknown well property correlation value is a transformed well property value.

3. The method of claim 2 wherein the well property value is a formation property value and, the method further comprises:
generating a local dynamic under-balance condition with a tool system;
measuring the transient pressure during the local dynamic under-balance condition with a pressure gauge of the tool system;
storing the transient pressure on the data storage device;
establishing the transient pressure characteristic value from the stored transient pressure; and
determining the at least one known well property value from the generated local dynamic under-balance condition.

4. The method of claim 3 wherein the formation property value is a formation property selected from a list comprising: reservoir pressure, formation permeability, formation porosity, formation transmissibility, formation mobility, skin factor, formation fluid viscosity, and formation fluid density.

5. The method of claim 2 wherein the transformed known well property value is created using a well property transform stored in the database, the well property transform being created by correlating aggregate transient pressure characteristic data and well property value data.

6. The method of claim 5 wherein the well property transform is created using a regression analysis of the aggregate transient pressure characteristic data and the well property value data.

7. The method of claim 6 wherein the well property transform is a mean-zero transformation.

8. The method of claim 2 further comprising:
obtaining a correlation transform from the database, the correlation transform representing the correlation between the transformed characteristic value and a summation of the at least one transformed known well property value and the transformed well property value;
calculating a transformed well property summation value by applying the transformed characteristic value to the correlation transform; and
calculating the transformed well property value by subtracting the at least one transformed known well property value from the transformed well property summation value.

9. The method of claim 3 wherein the transient pressure characteristic value is a first transient pressure characteristic value, and further comprising:
establishing a second transient pressure characteristic value from the stored transient pressure;
repeating the steps of the method with the second transient pressure characteristic value;
estimating a second well property value using the second transient pressure characteristic value;
reconciling the first well property value and the second well property value to determine the estimated well property value; and
storing the estimated well property value as the data value on the data storage device.

10. The method of claim 1 wherein the well property is a wellbore parameter, the wellbore parameter being selected from a list consisting of: initial wellbore pressure, casing inside diameter, wellbore fluid density, wellbore fluid compressibility, and wellbore fluid viscosity.

11. The method of claim 1 wherein the well property is a gun system parameter, the gun system parameter being selected from a list consisting of: a number of conventional charges, a number of special charges, shots per foot of conventional charges, shots per foot of special charges, explosive mass of conventional charges, explosive mass of special charges, gun outside diameter, gun length, perforated length, shot phasing, free gun volume, perforated hole diameter, and total opening area on the gun.

12. The method of claim 1 wherein the transient pressure characteristic value is selected from a list of values consisting of: first time characteristic (dt₁), second time characteristic (dt₂), third time characteristic (dt₃), fourth time characteristic (dt₄), DUB₁, DUB₂, Ω₁, and Ω₂.

13. A computer implemented method of estimating a transient pressure characteristic value of a future local dynamic under-balance condition generated in a hydrocarbon reservoir wherein a processor is coupled with a computer readable medium, the computer readable medium including a set of computer readable code, further wherein the processor executes the computer readable code, thus effectuating the following method, the method comprising:
selecting the transient pressure characteristic value to estimate;
establishing a data value representative of the selected transient pressure characteristic value, the data value being stored on a data storage device;
determining a set of at least two known well property values for the future local dynamic under-balance condition, the set of at least two known well property values being stored on the data storage device;
obtaining a transform for each of the known well property value from a database including a plurality of transforms, each of the obtained transforms correlating one of the known well property values to the selected transient pressure characteristic;
applying each of the known well property values in the set to the obtained transform for that known well property value to obtain a transformed known well property value for each of the known property values in the set;
summing the transformed known well property values to obtain a transformed well property summation;
transforming the data value by applying the transformed well property summation to a transformation correlating the well property summation with the selected transient pressure characteristic value to obtain a transformed characteristic value, and estimating the transient pressure characteristic value by applying the transformed characteristic value to an optimal transformation for the selected transient pressure characteristic value; and
storing the transformed data value representative of the selected transient pressure characteristic value on the data storage device; and
presenting the estimated transient pressure characteristic value on a graphical display.

14. The method of claim 13 further comprising:
generating a local dynamic under-balance condition with a tool system;
measuring the transient pressure during the local dynamic under-balance condition with a pressure gauge of the tool system;
storing the transient pressure on the data storage device;
measuring the selected transient pressure characteristic value; and
storing the measured selected transient pressure characteristic value on the data storage device.

15. The method of claim 14, further comprising:
comparing the measured selected transient pressure characteristic value from the data storage device to the estimated transient pressure characteristic value from the data storage device;
evaluating the accuracy of the selected transient pressure characteristic value estimation; and
presenting an indication of the evaluated accuracy on a graphical display.

16. The method of claim 13, further comprising evaluating the need to generate a future local under-balance condition based upon the estimated selected transient pressure characteristic value.

17. The method of claim 13, further comprising:
establishing a gun system defined by a plurality of gun system parameter values;
using the estimated transient pressure characteristic value from the data storage device to determine an optimal gun system parameter value;
modifying a gun system to implement the determined optimal gun system parameter value;
generating a local dynamic under-balance condition in the hydrocarbon reservoir with the modified gun system.

18. The method of claim 17 wherein the gun system parameter value is selected from a set of gun system parameters consisting of: a number of conventional charges, a number of special charges, shots per foot of conventional charges, shots per foot of special charges, explosive mass of conventional charges, explosive mass of special charges, gun outside diameter, gun length, perforated length, shot phasing, free gun volume, perforated hole diameter, and total opening area on the gun.

19. A computer implemented method of estimating an unknown well property value of a hydrocarbon reservoir, the method comprising:
generating a local dynamic under-balance condition within a hydrocarbon reservoir using a tool system, the tool system including a pressure gauge;
measuring the transient pressure during the local dynamic under-balance condition with the pressure gauge;
storing the measured transient pressure on a data storage device, wherein a processor is coupled with a computer readable medium including a set of computer readable code, wherein execution of the computer readable code by the processor effectuates the following steps:
establishing a data value representative of the unknown well property value, the data value being stored on the data storage device;
estimating a transient pressure characteristic value from the recorded transient pressure, the transient pressure characteristic value being stored on the data storage device;
determining a set of well property values comprising a plurality of known well property values and the unknown well property value, the set of well property values being stored on the data storage device;
transforming the data value by applying the transient pressure characteristic value stored on the data storage device to a predetermined correlation between the transient pressure characteristic and the set of well property values to estimate the unknown well property value from the application of the transient pressure characteristic value to the predetermined correlation;
storing the transformed data value representative of the estimated unknown well property value on the data storage device; and
presenting the estimated unknown well property value on a graphical display.

20. The method of claim 19 further comprising:
obtaining a transformed characteristic value by applying the transient pressure characteristic value to a transform;
obtaining transformed known well property values for each of the plurality of known well property values by applying each of the known well property values to a transform that relates the known well property value to the transient pressure characteristic value;
wherein the predetermined correlation is a correlation between the transformed characteristic value and a sum of the transformed well property values and the application of the transformed characteristic value to the predetermined correlation yields a summation of the transformed well property; and
wherein the unknown well property value is estimated by subtracting a summation of the plurality of transformed known well properties from the summation of the transformed well property set to obtain a transformed unknown well property value, the unknown well property value being estimated by applying the transformed well property value to a transform that relates the unknown well property value to the transient pressure characteristic value.
